(19) United States
(12) Patent Application Publication
(10) Pub. No.: US 2024/0362092 A1
(43) Pub. Date: Oct. 31, 2024

(54) OFFLOADING NETWORK COMMUNICATION OPERATION SYNCHRONIZATIONS TO ACCELERATOR STREAMS

(71) Applicant: HEWLETT PACKARD ENTERPRISE DEVELOPMENT LP, Spring, TX (US)

(72) Inventors: Naveen N. Ravichandrasekaran, Bloomington, MN (US); Krishna C. Kandalla, Bloomington, MN (US); James B. White, III, Bloomington, MN (US)

(21) Appl. No.: 18/307,212

(22) Filed: Apr. 26, 2023

(51) Int. Cl. G06F 9/54

(52) U.S. Cl. CPC G06F 9/545; G06F 9/542; G06F 2209/548

(57) ABSTRACT

A technique includes enqueueing, by a host processor of a compute node, a stream of first operations to be executed by an accelerator of the compute node. The stream is associated with a compute kernel boundary. The technique includes synchronizing a network operation to the compute kernel boundary; and offloading, by the host processor and to the accelerator, the synchronizing to the accelerator. The offloading includes enqueueing, by the host processor and to a network communication interface of the compute node, a network communication operation to be performed by the network communication interface. The offloading further includes adding, by the host processor and to the stream, a second operation to synchronize the network operation with the compute kernel boundary.

### BACKGROUND

A distributed system includes networked compute nodes that coordinate their processing activities to achieve a common goal. As an example, a high-performance computer (HPC) cluster is a distributed system that performs parallel processing to solve computationally complex problems. Other examples of distributed systems include database management systems, file storage systems, content delivery systems, software defined servers (SDSs) and cloud computing systems.

### BRIEF DESCRIPTION OF THE DRAWINGS

FIG. 1 is a block diagram of a distributed system having compute nodes with stream triggered communication-aware applications, according to an example implementation.

FIG. 2 is a flow diagram depicting a sequence used by a host process to offload, to a GPU stream, control paths related to synchronizing compute kernel boundaries with network communication operations, according to an example implementation.

FIG. 3A is an illustration of a trigger event sequence used by a host process to enqueue a GPU trigger kernel to trigger execution of a set of one or multiple network communication operations according to an example implementation.

FIG. 3B is an illustration of a trigger event sequence used by a host process to enqueue a GPU “write_value” memory stream operation to trigger execution of a set of one or multiple network communication operations according to an example implementation.

FIG. 4A is an illustration of a completion event sequence used by a host process to enqueue a GPU wait kernel to cause a GPU core thread to wait for completion of a set of one or multiple network communication operations according to an example implementation.

FIG. 4B is an illustration of a completion event sequence used by a host process to enqueue a “wait_value” memory stream operation to cause a GPU processor to wait for completion of a set of one or multiple network communication operations according to an example implementation.

FIG. 4C is an illustration of chaining of a signal operation to a network communication operation according to an example implementation.

FIG. 5 is an illustration of two-sided messaging used by a host process to synchronize network communication operations with compute kernel boundaries according to an example implementation.

FIG. 6 is a flow diagram depicting a process-to-process messaging used by a host process to synchronize network communication operations with compute kernel boundaries according to an example implementation.

FIG. 7 is a flow diagram depicting a technique to offload, to an accelerator, synchronization of a network communication operation with a compute kernel boundary according to an example implementation.

FIG. 8 is an apparatus having a processor to enqueue a synchronization kernel to cause a GPU to synchronize a network communication operation with a compute kernel boundary according to an example implementation.

FIG. 9 is an illustration of a non-transitory machine-readable storage medium that stores machine-readable instructions that, when executed by a machine, cause the machine to enqueue a trigger event in a sequence of operations to cause an accelerator to initiate network communication according to an example implementation.

### DETAILED DESCRIPTION

The following detailed description refers to the accompanying drawings. Wherever possible, the same reference numbers are used in the drawings and the following description to refer to the same or similar parts. It is to be expressly understood, however, that the drawings are for the purpose of illustration and description only. While several examples are described in this document, modifications, adaptations, and other implementations are possible. Accordingly, the following detailed description does not limit the disclosed examples. Instead, the proper scope of the disclosed examples may be defined by the appended claims.

The terminology that is used herein is for the purpose of describing particular examples only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “connected,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

A distributed system includes networked compute nodes that coordinate their processing activities to achieve a common goal. In an example, a high-performance computer (HPC) cluster is a distributed system that performs parallel processing to solve computationally complex problems. A distributed system may process units of work called “jobs,” such as jobs that are associated with a distributed application. One or multiple compute nodes of the distributed system may process compute kernels that correspond to different parts of a job. More specifically, a given job may specify certain processing functions (e.g., scatter functions, reduce functions, gather functions), which are referred to as “compute kernels.” The compute kernels of a given job may be executed in parallel by different parallel processes called “ranks.” In the context that is used herein, a “process” refers to an instance of a program, such as an instance of a particular application. Each process may be associated with one or multiple processing cores of a compute node.

The processes may communicate via inter-process communications for such purposes as transferring data (e.g., transferring compute kernel input data or compute kernel output data) and synchronizing the executions of the compute kernels. The communications may involve the use of messaging, such as messaging according to the Message Passing Interface (MPI) protocol communication standard.

A compute node may include one or multiple host processors, such as general-purpose host processors (e.g., one or multiple central processing unit (CPU) cores or one or multiple CPU packages, or “sockets”), which execute an application that may correspond to a local component of a distributed application. The application may have multiple associated host processes, with each host corresponding to, for example, a particular rank. The host process controls the general workflow of the processing of the rank and may offload computationally complex compute kernels (e.g., compute kernels involving floating point arithmetic operations) to an accelerator of the compute node. A graphics processing unit (GPU) is an example of an accelerator.

In general, an accelerator has an architecture with features that accommodate computationally complex processing, such as processing involving operations on numeric arrays, artificial intelligence, data analytics and three-dimensional video rendering. In general, a compute kernel may correspond to a function that is executed multiple times in parallel by different threads of the accelerator. A host process may initiate execution of a compute kernel through a corresponding kernel launch. A “kernel launch,” in this context, refers to an instruction by the host process to execute a particular compute kernel. A kernel launch may include arguments that identify a particular compute function, specify how many threads are to be used, and specify how many groups of threads to use, among other possible arguments.

An accelerator may concurrently process multiple streams. In this context, a “stream” refers to a sequence of device operations for an accelerator. A first stream that launches execution of a first compute kernel (or “launches the first compute kernel”) may execute concurrently and independently with respect to a second stream that launches a second compute kernel. The ability of the accelerator to process multiple concurrent streams leads to a more efficient use of the accelerator's resources (as opposed to, for example, the resources of the accelerator being idle while the accelerator processes a particular compute kernel). Multiple kernels may be enqueued to a single stream, and these kernels are then executed in the order that they are enqueued.

In one approach, a host process may participate in moving, or staging, data for the accelerator. For example, in response to the accelerator completing execution of a compute kernel, a host process may move data (e.g., output data) from an accelerator-attached buffer to a host processor-attached buffer and then initiate a communication operation to transfer the output data to another process. To alleviate the burden on the host process transferring data to and from accelerator-attached buffers, a compute node may have an application and a system software stack that use an “accelerator-aware” communication library, which allows inter-compute node and intra-compute node data transfers without host process participation.

Even with accelerator awareness, a host process may still orchestrate data-moving communications and inter-process synchronization operations, which may impact the parallel processing performance of the distributed system. For example, a host process may enqueue a compute kernel for execution by an accelerator and wait for the accelerator to execute the compute kernel. The completion of the compute kernel execution is a synchronization point for the host process and is an example of a “compute kernel boundary” herein. In this context, a “compute kernel boundary” refers to the initiation of execution of a compute kernel by the accelerator or the completion of execution of a compute kernel by the accelerator.

When a synchronization point is reached, the host process may instruct a network interface controller of the compute node to initiate a set of one or multiple network communication operations (or “payload data transfer operations”). In an example, a network communication operation may be an operation to communicate payload data between the network interface controller and a network interface controller of another compute node. The host process may subsequently wait for the network communication operation(s) to complete before the host process launches another compute kernel. In an example, a network communication operation may include communicating data (e.g., result data produced by the execution of a compute kernel) to another process. In another example, the network communication operation may communicate data (e.g., input data for the next compute kernel execution) to the host process.

A host process waiting for one or multiple network communication operation(s) to complete corresponds to a second synchronization point, which is an example of another compute kernel boundary. When the set of network communication operations complete, the host process may proceed with launching the next compute kernel. The host process orchestrating the synchronization of network communication operations with compute kernel boundaries may be considerably expensive, in terms of time and processing resources, and accordingly may impact the parallel processing performance of the distributed system.

In accordance with example implementations that are described herein, a host process offloads, to the accelerator, the control paths for synchronizing network communication operations and compute kernel boundaries. More specifically, in accordance with example implementations, a host process enqueues synchronization events to an accelerator stream of device operations. The synchronization events, in turn, correspond to compute kernel boundaries and cause the accelerator (instead of the host process) to control the synchronization of network communication operations with compute kernel boundaries.

In an example, a compute kernel boundary may correspond to the completion of execution of a particular compute kernel by an accelerator, and the host process may undertake a trigger event sequence to offload, from the host process and to the accelerator, a synchronization point related to communicating payload data across the network. Pursuant to the trigger event sequence, the host process enqueues a trigger event to the accelerator stream (e.g., enqueue a trigger event that follows a kernel launch in the stream). The trigger event is used to trigger and execute a set of network communication operations by a network interface controller (NIC) of the compute node. The trigger event is sequenced in the accelerator stream so that the accelerator executes the trigger event after the accelerator completes execution of the compute kernel. The accelerator's execution of the trigger event causes the accelerator to provide a signal (e.g., write data to a certain memory location), which is referred to as a “trigger” herein.

In accordance with example implementations, in addition to enqueuing a trigger event to the accelerator stream, the trigger event sequence further includes the host process enqueuing a set of one or multiple triggered network communication operations to a triggered operating queue of the NIC. The set of triggered network communication operations are synchronized to the completion of the compute kernel execution, such that the set is triggered, or initiated, by the trigger that is provided by the accelerator.

In another example, the compute kernel boundary may correspond to the launching of a particular compute kernel by the accelerator, and the host process may undertake a completion event sequence to offload, from the host process and to the accelerator, a synchronization point related to waiting for payload data to be communicated across the network. Pursuant to the completion event sequence, the host process enqueues a completion event to the accelerator stream. The host process may further enqueue a compute kernel to the accelerator stream after the completion event. The completion event causes the accelerator to wait for a set of one or multiple network communication operations to complete before proceeding with the next operation (e.g., a compute kernel launch) of the accelerator stream.

In accordance with example implementations, in addition to enqueuing a completion event to the accelerator stream, the completion event process further includes the host process enqueuing a triggered signal operation to the triggered operation queue of the NIC. The triggered signal operation is triggered, or initiated, in response to a set of network communication operation(s) completing. In this manner, responsive to the network communication operations completing, the NIC initiates the triggered signal operation, which signals the accelerator to notify, or alert, the accelerator (which is processing the completion event) to the completion of the set of network communication operations.

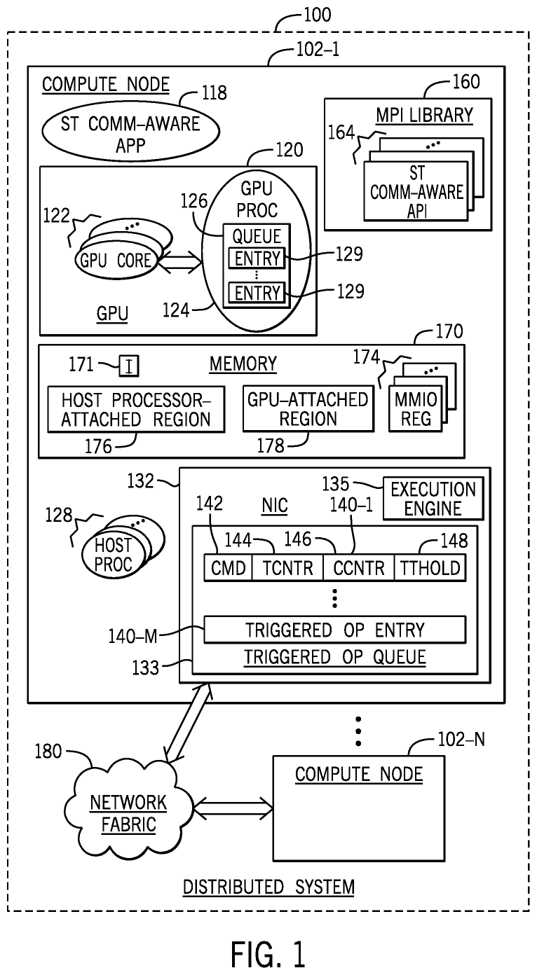

Referring to FIG. 1, as a more specific example, in accordance with some implementations, a distributed system 100 may include one or multiple compute nodes 102. For the specific implementation that is depicted in FIG. 1, the distributed system 100 includes N compute nodes 102 (compute nodes 102-1 and 102-N being depicted in FIG. 1). FIG. 1 depicts specific components of the compute node 102-1. Other compute nodes 102 may have similar architectures, in accordance with example implementations. In accordance with example implementations, the compute nodes 102 coordinate processing activities to achieve a common goal. In an example, distributed system 100 may be a parallel processing system (e.g., a high-performance computing (HPC) cluster), and the ranks for a given job may be distributed among one or multiple compute nodes 102. In an example, the compute node 102 may be a logical or physical entity that is associated with a single instance of an operating system 164.

As an example, a compute node 102 may be hosted by an entire computer platform or a subpart thereof. In this context, a “computer platform” refers to an electronic device that has a processing resource, which is capable of executing machine-readable instructions (or “software”). As examples, a computer platform may be a server computer (e.g., a blade server, a rack server, or a standalone server), a desktop computer, a notebook computer, a tablet computer, a smartphone, a storage array, a network switch, a wearable computer, a network gateway, or another electronic device that has a processing resource. As an example, the compute node 102 may correspond to one or multiple central processing unit (CPU) cores of the computer platform. As a more specific example, the computer platform may be a blade server, and CPU cores of the blade server may be partitioned among multiple compute nodes 102.

As another example, a compute node 102 may be a host abstraction (e.g., a container, a virtual machine, or another host abstraction) of a single computer platform or a subpart thereof. As another example, a compute node 102 may be a host abstraction across multiple computer platforms (e.g., a single virtual machine hosted across multiple computer platforms, such as a software-defined server).

Regardless of its particular form, the compute node 102 has associated hardware and software. FIG. 1 depicts specific hardware and software components of a specific compute node 102-1 and is specifically described herein. Other compute nodes 102 may have similar or different architectures and/or components to/from the compute node 102-1, in accordance with further implementations. For the example implementation that is depicted in FIG. 1, the hardware may include a collection of general-purpose physical processors 108, which are referred to herein as “host processors 108.” As used herein, a “collection” of items, such as a collection of physical host processors 108, can refer to a single item or multiple items. A host processor 108 may include a microprocessor, a core of a multi-core microprocessor, a microcontroller, a programmable integrated circuit, a programmable gate array, or another hardware processing circuit. As more specific examples, in accordance with some implementations, the host processor 108 may be a central processing unit (CPU) core, a collection of CPU cores, or a CPU semiconductor package (or “socket”).

The compute node 102-1 may also include one or multiple accelerators. In this context, an “accelerator” refers to a physical processor that has features that impart an enhanced ability to the processor to perform computational operations (e.g., numeric array processing, parallel processing compute functions (e.g., reduce, scatter and gather operations), or other computational operations), as compared to a general-purpose processor (e.g., a CPU). In accordance with example implementations that are described herein, the accelerator is a GPU 120. In accordance with example implementations, the compute node 102-1 may include multiple GPUs 120. In accordance other examples, the accelerator may be a digital signal processor (DSP), a field programmable gate array (FPGA), or other circuit.

The compute node 102-1 may further include a physical memory 170, which may be implemented using a collection of physical memory devices. In general, the memory devices that form the physical memory 170, as well as other memories and storage media that are described and are referenced herein, are examples of non-transitory machine-readable storage media. In accordance with example implementations, the machine-readable storage media may be used for a variety of storage-related and computing-related functions of the compute node 102-1. As examples, the memory devices may include semiconductor storage devices, flash memory devices, memristors, phase change memory devices, magnetic storage devices, a combination of one or more of the foregoing storage technologies, as well as memory devices based on other technologies. Moreover, the memory devices may be volatile memory devices (e.g., dynamic random access memory (DRAM) devices, static random access (SRAM) devices, and so forth) or non-volatile memory devices (e.g., flash memory devices, read only memory (ROM) devices, and so forth), unless otherwise stated herein.

The memory 170, in accordance with example implementations, may store machine-readable instructions 171 (or “software”), which may be executed by one or multiple host processors 108 for purposes of providing software component instances for the compute node 102-1. For example, in accordance with some implementations, the instructions 171, when executed by the host processor(s) 108, may cause the host processor(s) 108 to form one or multiple stream triggered communication-aware application instances 118 (also called “applications 118” or “application instances 118” herein). A particular application instance 118 corresponds to a host process and may be associated with a particular rank for a parallel processing job. In an example, instructions 171, when executed by the host processor(s) 108, may cause the host processor(s) 108 to form an operating system instance 164 (also called an “operating system 164” herein).

In accordance with example implementations, the application 118 is “stream-triggered communication-aware” due to the application 118 being instructed (as described herein) to offload, to the GPU 120, control paths related to synchronizing network communication operations with compute kernel boundaries. In this manner, instead of a host process having synchronization points that corresponds to compute kernel boundaries, the host process instead offloads the synchronization points to a stream of device operations (called a “GPU stream” herein), which is processed by the GPU 120. In the context used herein, a “host process” refers to a sequence of machine-readable instructions that correspond to the application 118 and are executed by a host processor 128. A given host process may be associated with one or multiple threads, and a given host process may be associated with one or multiple processing cores of the host processor 128.

As part of being stream triggered communication-aware, the host process makes application programming interface (API) calls to stream triggered communication-aware APIs 164. In an example, a host process may use the APIs 164 to perform two-sided communications to offload trigger events and completion events to the GPU stream. In another example, a host process may use the APIs 164 to perform two-sided communications to offload triggered operations to a network interface controller (NIC) 132 of the compute node 102-1, such as triggered network communication operations and triggered signal operations.

The memory 170 may include a region 176 that is associated with the host processors 108 and a region 178 that is associated with the GPU 120. The regions 176 and 178 may be referred to as a “CPU-attached region” and a “GPU-attached region,” respectively. The memory 170 may also include one or multiple memory-mapped input/output (MMIO) registers 174. An MMIO register 174 refers to a region of memory space that is mapped to an I/O space. As further described herein, the MMIO registers 174 may be used to communicate signals between I/O space and memory space.

The GPU 120, in accordance with example implementations, may include a processor 124 (herein called a “GPU processor”) and GPU cores 122. In accordance with example implementations, the GPU processor 124 schedules and executes GPU kernel operations that are enqueued by a host process in a command queue 126. The GPU processor 124 may have any of a number of different architectures, depending on the particular implementation. In an example, in accordance with some implementations, the GPU processor 124 may include one or multiple circuits. For example, the circuits may be hardware processing circuits, which can include any or some combination of a microprocessor, a core of a multi-core microprocessor, a microcontroller, a programmable integrated circuit (e.g., a programmable logic device (PLD), such as a complex PLD (CPLD)), a programmable gate array (e.g., field programmable gate array (FPGA)), an application specific integrated circuit (ASIC), or another hardware processing circuit. In accordance with some implementations, the GPU processor 124 may be software-based, and as such the GPU processor 124 may be formed from one or multiple hardware processors executing machine-readable instructions (or “software”). In accordance with some implementations, the software instructions may be operating system kernel instructions of the GPU 120. Alternatively, the GPU processor 124 may include one or multiple hardware processing circuits that do not execute machine-readable instructions, or a combination of one or multiple hardware processing circuits that do not execute instructions and one or multiple circuits that execute instructions.

Regardless of its particular architecture, in accordance with example implementations, the GPU processor 124 is constructed to perform two general functions. First, the GPU processor 124 is constructed to schedule the launches and teardowns of GPU kernels (e.g., compute kernels) that are enqueued in the queue 126. Secondly, the GPU processor 124 is constructed to launch and execute stream memory operations, such as a “write_value” stream memory operation (to write a value to a location of the memory 170) and a “wait_value” stream memory operation (to poll a location of the memory 170 for certain value). GPU kernels are launched by the GPU processor 124 and executed by the GPU cores 122 on GPU threads, thread blocks and grids. The “write_value” and “wait_value” stream memory operations are executed directly by the GPU processor 124 (e.g., executed using GPU vendor-specified semantics and mechanisms).

In accordance with example implementations, the device operations of the GPU stream may have corresponding descriptors that are stored in respective entries 129 of the queue 126. The queue 126 may be a first-in-first-out (FIFO) buffer that establishes the order in which the GPU processor 124 processes the device operations. In an example, a descriptor may describe a compute kernel launch (e.g., the initiation of execution of a compute kernel by one or multiple GPUs 122) and have arguments that identify properties associated with the compute kernel, such as a function identity; a number of threads per group, or block; and a number of blocks.

The GPU stream may also have device operations, which are referred to as “synchronization events” herein, which synchronize compute kernel boundaries to triggered operations that are performed by the NIC 132. In an example, the synchronization event may be a “completion event,” which causes the GPU 120 to wait for completion of an event (e.g., completion of one or multiple network communication operations by the NIC 132) before proceeding with processing another operation (e.g., initiating execution of a compute kernel) of the GPU stream. Waiting for the completion may involve the GPU 120 polling a memory location, as further described herein. In another example, the synchronization event may be a trigger event that causes the GPU 120 to generate a trigger for purposes of causing the NIC 132 to initiate one or multiple triggered network communication operations.

As depicted in FIG. 1, in accordance with example implementations, the NIC 132 may include a triggered operation queue 133. The triggered operation queue 133 allows the NIC 132 to be configured with a list of operations that are delayed, or deferred, until certain conditions are satisfied. In an example, the deferred operations may be represented by respective triggered operation queue entries 140, which are stored in the triggered operation queue 133. FIG. 1 depicts M entries 140 (with entries 140-1 and 140-M being specifically shown in FIG. 1). In accordance with example implementations, the triggered operation queue 133 may be stored in a memory of the NIC 132, and the entries 140 may be processed by an execution engine 135 of the NIC 132. The execution engine 135 may be hardware (e.g., a processor core) that executes machine-readable instructions, hardware that does not execute machine-readable instructions, or a combination of hardware that executes machine-readable instructions and hardware that does not execute machine-readable instructions.

FIG. 1 depicts an example structure for an entry 140-1 of the triggered operation queue 130. Other entries 140 may have a similar structure, in accordance with example implementations. The entry 140-1 includes a command descriptor 142 that represents a command that instructs the execution engine 135 of the NIC 132 to perform an operation. In an example, a command may correspond to a network communication operation. For example, a command descriptor 142 may instruct the NIC 132 to perform a network send, or put, operation in which the NIC 132 puts payload data (e.g., one or multiple packets containing payload data) to another compute node 102. As another example, a command descriptor 142 may instruct the NIC 132 to perform a network receive, or get, operation in which the NIC 132 gets payload data (e.g., one or multiple packets containing payload data from another compute node 102).

In another example, a command descriptor 142 may correspond to an operation to cause the NIC 132 to perform what is referred to herein as a “signaling operation.” A signaling operation, in this context, refers to an operation in which the NIC 132 performs an intra-node communication to alert, or notify, another component of the compute node 102-1. In an example, a signaling operation may notify the GPU 120 to the completion of a particular set of network communication operations. In an example, as further described herein, a command descriptor 142 that is associated with a signaling operation may set forth a command that is triggered by the completion of a set of network communication operations and cause the NIC 132 to write a value to a location of the GPU-attached region 178, which notifies the GPU 120 that the operations have completed.

In addition to a command descriptor 142, an entry 140 may further include data that represents a triggering condition for the command that is described by the command descriptor 142. As depicted in FIG. 1, the entry 140-1 includes data that identifies a particular trigger counter 144 (out of potentially multiple trigger counters) of the NIC 132, and the entry 140-1 includes data that represents a trigger count threshold 148. In accordance with example implementations, the execution engine 135 executes the command set forth by the command descriptor 142 in response to the identified trigger counter 144 reaching a specified trigger count threshold 148.

In an example, the entry 140-1 may contain a command descriptor 142 that describes a command for the NIC 132 to perform a network put operation. Here, the “network put operation” refers to a network communication operation to transfer payload data from the compute node 102-1 to another compute node 102. In addition to enqueuing such an entry 140-1 in the triggered operation queue 133, the host process may further enqueue a trigger event to the GPU stream after a particular compute kernel launch instruction, which causes the GPU 120 to generate a trigger after completion of the execution of the compute kernel. In an example, the trigger event may cause the GPU 120 to write a value to a trigger counter that is identified by the entry 140-1, such that the value meets or exceeds a trigger count threshold that is specified by the entry 140-1. Therefore, the host process may offload coordination of the synchronization related to network communication operations that occur after execution of a particular compute kernel by enqueueing a trigger event in the GPU stream and using the deferred operation capability of the NIC 132. As described further herein, in accordance with example implementations, the trigger event may be either a kernel operation that is executed by a GPU core 122 or a “write_value” memory stream operation that is executed by the GPU processor 124.

In accordance with example implementations, the completion of an operation by the NIC 132 is represented by data 146 of the entry 140-1 that corresponds to a completion counter of the NIC 132 (i.e., identifies a particular completion counter of the NIC 132). Through entry chaining, as further described herein, the completion of a set of network communication operations by the NIC 132 may be used to initiate, or trigger, a signaling operation by the NIC 132 to write a value to a location of the GPU-attached region 178 to alert the GPU 120 to the completion. Entry chaining may be particularly beneficial when the GPU 120 is unable to poll the I/O space of the NIC 132 (whether directly or through an MMIO register 174) for the count value of a completion counter 146 that indicates whether the set of network communication operations has completed. In this manner, the GPU 120 may instead poll a location of the GPU-attached region 178, which is written by the NIC 132 in a signaling operation that is chained to the set of network communication operations. As described further herein, depending on the type of completion event that enqueued to the GPU stream, either the GPU processor 124 or a GPU core thread may poll the GPU-attached region 178 to learn when a particular set of network communication operations has completed.

In an example, multiple entries 140 may specify the same trigger counter 144 and different trigger count thresholds 148, so that a sequence of corresponding operations (e.g., a set of network communication operations) may be initiated by a particular trigger. In another example, multiple entries 140 may have the same trigger counter 144 and the same trigger count threshold 148, so that the operations corresponding to these entries 140 may be triggered with a single update to the trigger counter 144. In another example, the trigger counter and completion counter may be different for different entries 140 so that the operations corresponding to the entries 140 may be initiated independently. In general, the execution of an operation associated with a particular entry 140 will not impact the execution of an operation associated with another entry 140 unless the entries 140 are related.

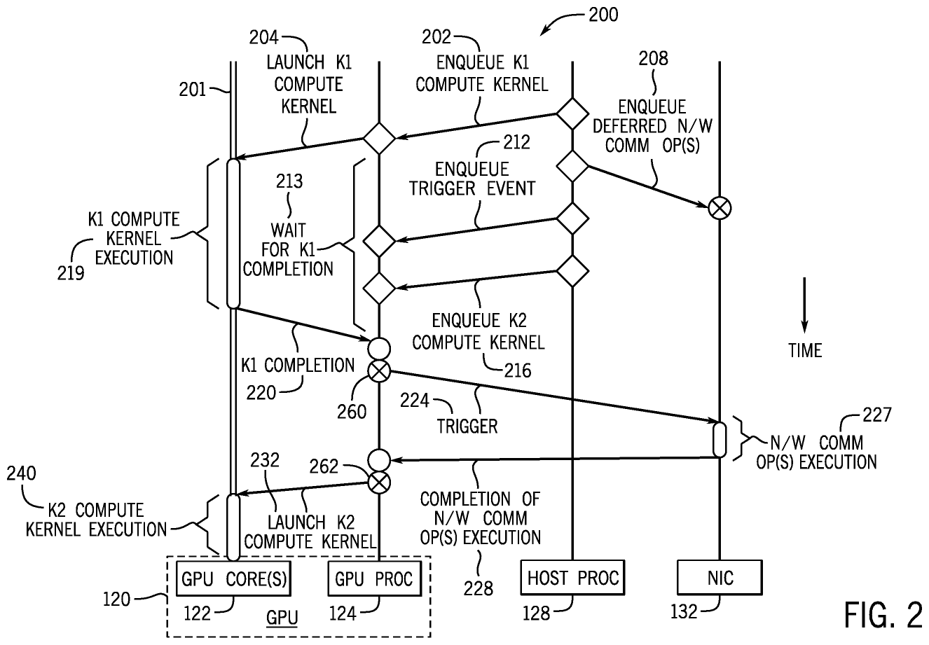

FIG. 2 depicts a sequence 200 of communications among GPU core(s) 122; the GPU processor 124; a host processor 128, which is associated with a host process; and the NIC 132 for purposes of offloading communication control paths from the host process to the GPU 120 according to example implementations. Referring to FIG. 2, for this example, the host processor 128 may enqueue a K1 compute kernel launch instruction to the queue of the GPU processor 124, as depicted at 202. Responsive to the K1 compute kernel launch instruction, the GPU processor 124 may launch execution of the K1 compute kernel, as depicted at 204, so that one or multiple GPU cores 122 execute the K1 compute kernel, as depicted at 219.

For this example, the completion of the execution of the K1 compute kernel by the GPU core(s) 122 corresponds to a kernel boundary, which is to be synchronized to one or multiple payload data transfers, or network communication operations, which are performed by the NIC 132. In an example, the network communication operations may include a network communication operation to put output data produced by the K1 compute kernel execution to another process associated with another rank. In another example, the network communication operations may include a network communication operation to get input data produced by a compute kernel execution associated with another process.

For purposes of synchronizing the network communication operation(s) to the kernel boundary, the host processor 128 may perform a series of operations according to a trigger event sequence. Pursuant to the trigger event sequence, the host processor 128 may enqueue a set of one or multiple deferred, or triggered, network communication operations to a triggered operation queue of the NIC 132, as depicted at 208. In an example, the enqueuing of a particular operation may include enqueueing an entry to the queue, which specifies a command descriptor, identifies a trigger counter, identifies a completion counter, and specifies a trigger count threshold.

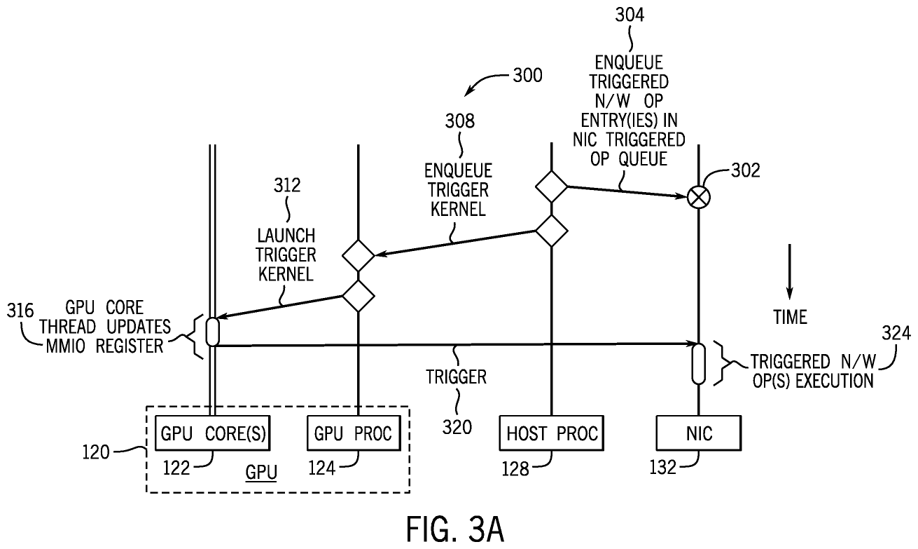

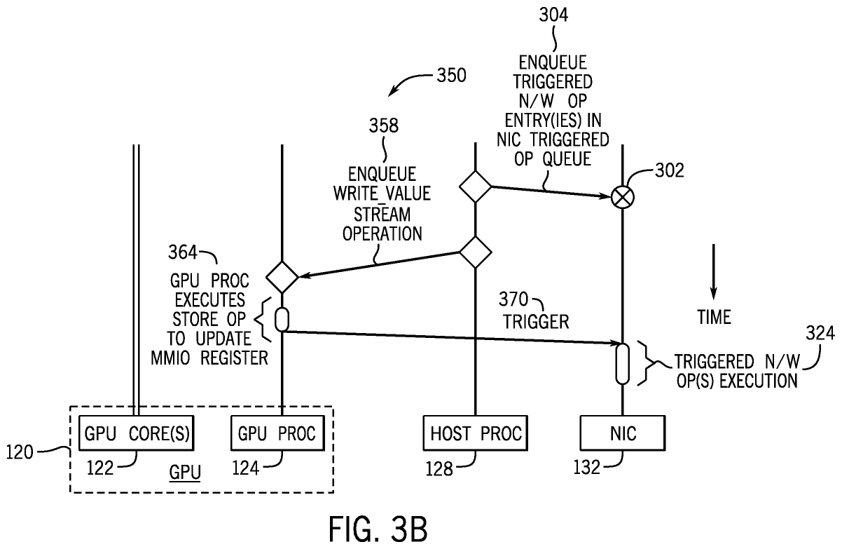

Also pursuant to the trigger event sequence, the host processor 128 enqueues a trigger event to the GPU 120. As further described herein, in accordance with example implementations, the trigger event may be one of two types: a GPU trigger kernel (as described below in connection with FIG. 3A) that is ultimately executed by a GPU core thread; or a GPU “write_value” memory stream operation (as described below in connection with FIG. 3B) that is executed directly by the GPU processor 124. As also depicted in FIG. 2, the host processor 128 may enqueue additional commands in the GPU processor's command queue, such as a command instructing the GPU processor 124 to launch a K2 compute kernel, as depicted at 216.

Before the GPU processor 124 launches the K2 compute kernel, the GPU processor 124 first waits (as depicted at 213) for the completion of the execution of the K1 compute kernel before the GPU processor 124 executes the next set of instruction(s) corresponding to the trigger kernel. As depicted at 220, when the GPU cores 122 indicate that execution of the K1 compute kernel is complete, this corresponds to a synchronization point 260 of the GPU stream. Corresponding to the synchronization point 260, the GPU processor 124 executes the trigger event to launch (as depicted at 224) a trigger to initiate the network communication operation(s). As depicted at 227, the NIC 132 responds to the trigger to execute the network communication operation(s). As depicted at 228, the GPU processor 124 waits (as described further herein) for the network communication operations to complete (which corresponds to another synchronization point as further described herein) before launching execution of the K2 compute kernel, as depicted at 232. One or multiple GPU cores may then execute the K2 compute kernel, as depicted at 240.

FIG. 3A depicts a triggered event sequence 300 that uses a GPU trigger kernel to generate a trigger 320, according to example implementations. Referring to FIG. 3A, the triggered event sequence 300 includes the host processor 128 enqueuing one or multiple triggered network communication operation entries in the triggered operations queue of the NIC 132, as depicted at 302 and 304. The triggered event sequence 300 further includes the host processor 128 enqueuing a GPU trigger kernel to the queue of the GPU processor 124, as depicted at 308.

The GPU trigger kernel, when executed by the GPU processor 124, causes the GPU processor 124 to launch a kernel into a GPU core thread (as depicted at 312). The GPU core thread then update an MMIO register through a store operation with a value that represents the trigger 320 to initiate the NIC's execution of the triggered set of network communication operations, as depicted at 324. In an example, the GPU core thread may write a trigger count threshold value to an MMIO register location that is mapped to a trigger counter of the NIC 132. The trigger count threshold count and the trigger counter, in turn, may correspond to the set of network communication operations such that the write causes the NIC 132 to initiate the set of network communication operations.

FIG. 3B depicts a triggered event sequence 350 that uses a GPU “write_value” memory stream operation to generate a trigger 370, according to example implementations. Referring to FIG. 3B, similar to the triggered event sequence 300 (FIG. 3A), the triggered event sequence 350 includes the host processor 128 enqueuing one or multiple triggered network communication operation entries in the triggered operations queue of the NIC 132, as depicted at 302 and 304. The triggered event sequence 350 further includes the host processor 128 enqueuing a “write_stream” value memory stream operation to the to the queue of the GPU processor 124, as depicted at 358.

In contrast to the GPU trigger kernel (FIG. 3A), which is executed by a GPU core thread, the “write_value” memory stream operation is executed directly by the GPU processor 124. The execution of the “write_value” memory stream operation causes the GPU processor 124 to execute a store operation to update an MMIO register location (as depicted at 364) with a value that represents a trigger 370 to initiate the NIC's execution of the triggered set of network communication operations, as depicted at 324. In an example, the GPU processor 124 may write a trigger count threshold value to an MMIO register location that is mapped to a trigger counter of the NIC 132. The trigger count threshold count and the trigger counter, in turn, may correspond to the set of network communication operations such that the write causes the NIC 132 to initiate the set of network communication operation(s).

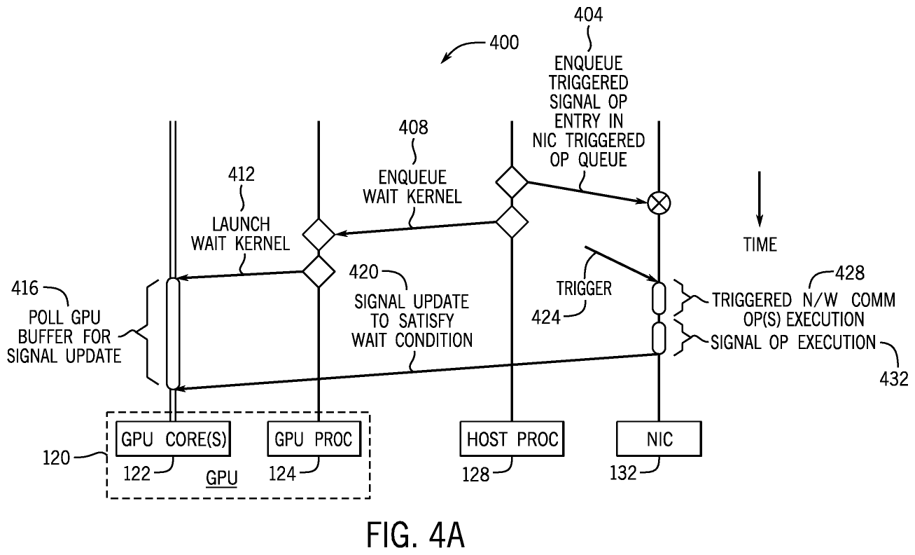

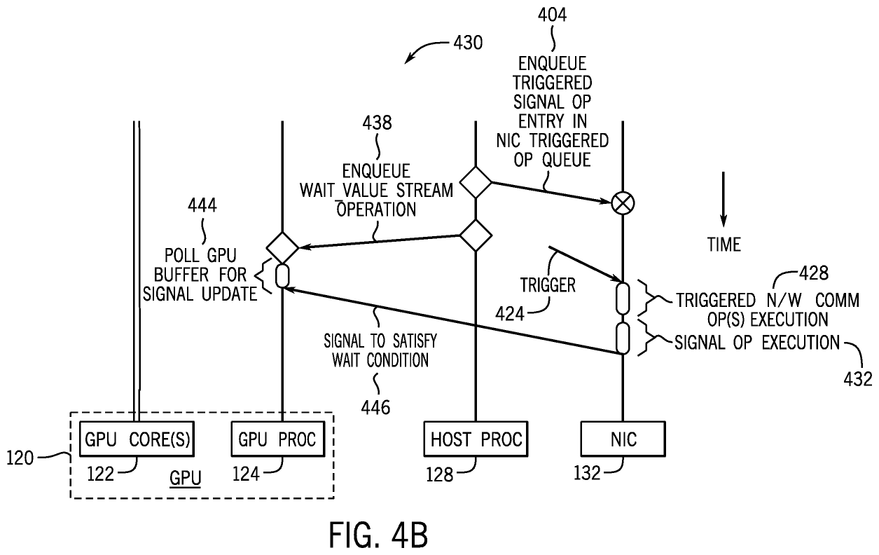

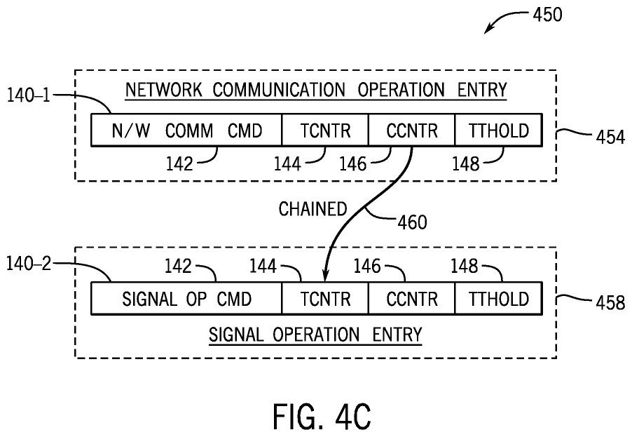

FIG. 4A depicts a completion event sequence 400 that uses a GPU wait kernel to cause the GPU 120 to wait for completion of a set of network communication operations, according to an example implementation. Referring to FIG. 4A, the completion event sequence 400 includes the host processor 128 first enqueuing one or multiple triggered signal operation entries in the deferred work queue of the NIC, as depicted at 404. As further described below in connection with FIG. 4C, in accordance with example implementations, the signal operation entry is chained to the set of network communication operations to cause the NIC 132 to provide a signal to the GPU-attached memory to notify the GPU 120 of the completion of the operations. The completion event sequence 400 further includes the host processor 128 enqueuing a GPU wait kernel to the queue of the GPU processor 124, as depicted at 408.

In accordance with example implementations, the GPU wait kernel, when executed by the GPU processor 124, causes the GPU processor 124 to launch (as depicted at 412) a kernel that is executed by a GPU core thread. The GPU core thread, in response to the execution of the kernel, polls (as depicted at 416) a location of GPU-attached memory, waiting for the signal operation to write a value to the location, which indicates that the set of network communication operations has completed. The enqueued set of network communication operations is triggered (as depicted at 424) and execute (as depicted at 428). The set of network communication operations complete and due to entry chaining, the completion of the set of network communication operation(s) triggers the signal operation execution, as depicted at 432. The NIC's execution of the signal operation, in turn, produces a signal to satisfy the wait condition of the kernel that is executed by the GPU core thread. In accordance with example implementations, the signaling by the signal operation corresponds to a write of a value to the GPU-attached memory location that is polled by the GPU core thread.

FIG. 4B depicts a completion event sequence 430 that uses a GPU “wait_value” memory stream operation to wait for completion of a set of network communication operations, according to an example implementation. Referring to FIG. 4B, the completion event sequence 430 includes the host processor 128 first enqueuing one or multiple triggered signal operation entries in the deferred work queue of the NIC, as depicted at 404. The completion event sequence 430 further includes the host processor 128 enqueuing a “wait_value” memory stream operation to the queue of the GPU processor 124, as depicted at 438.

In accordance with example implementations, the “wait_value” memory stream operation is executed directly by the GPU processor 124 to cause the GPU processor 124 to poll (as depicted at 444) a location of GPU-attached memory, waiting for the signal operation to write a value to the location, which indicates that the set of network communication operations has completed. The enqueued set of network communication operations is triggered (as depicted at 424) and executed (as depicted at 428). The set of network communication operations complete and due to entry chaining, the completion of the set of network communication operations triggers the signal operation execution, as depicted at 432. The NIC's execution of the signal operation, in turn, produces a signal to satisfy the wait condition that is imposed by the polling 444 by the GPU processor 124.

FIG. 4C illustrates a particular network communication operation entry 454 of the NIC's triggered operation queue being linked, or chained, to a signal operation entry 458 of the triggered operation queue. The network communication operation entry 454 may correspond to a triggered operation queue entry 140-1 that includes a network communication operation command directed to causing the NIC 132 to perform a network communication operation that transmits or receives a payload to or from another compute node. For this example, the entry 140-1 may identify a completion counter 146 that is linked, or chained, as depicted at 460, to a trigger counter 144 that is identified by another entry 140-2 of the triggered operation queue, which corresponds to the signal operation entry 458. For this example, the entry 140-2, when executed, causes the NIC 132 to provide a signal to notify the GPU 120 to the completion of the network communication operation. In accordance with example implementations, the entry 140-2 may include a command descriptor 142 that contains an atomic write operation. Here, the atomic write operation refers to the operations specified by the entries 140-1 and 140-2 being tied together as a unit. The NIC 132 executes the command specified by the command descriptor 142 of the descriptor 140-2 when the completion counter 146 for the network communication operation entry 454 reaches a value that both indicates completion of the network operation and activation of the signal operation.

In accordance with some implementations, the host processor 128 may use two-sided communications, such as MPI active remote memory access (RMA) communications to enqueue synchronization kernels (e.g., trigger kernels and wait kernels) into the GPU stream, and enqueue the triggered network communication operations and signal operations into the NIC 132. The MPI RMA communication model supports using window creation for exposing remote accessible memory locations, one-sided data movement operations, and synchronization operations. For the two-sided communications, a memory window is first established. In this context, a “memory window” refers to memory locations in which data may be moved, including GPU-attached memory, host-attached memory, and memory associated with a NIC. Synchronization operations for both the origin process (the process initiating the communication) and target process to create the window and free the window ensure memory consistence and coherence.

An RMA synchronization operation at the target process starts an exposure epoch, which allows the origin process to start accessing the memory window. A synchronization operation at the origin process starts an access epoch, which allows the origin process to issue data movement processes on the remotely accessible memory window. RMA data movement operations offer non-blocking semantics. Here, “non-blocking” refers to an operation associated with a call that returns immediately before the buffer associated with the operation has been emptied (for puts) or filled (for gets). The MPI RMA communication uses RMA epochs, with are execution spans between synchronization operations. MPI RMA data movement operations (e.g., “MPI_Put,” “MPI_Get,” and “MPI_Accumulate”) are performed within an epoch. Moreover, multiple data transfers may occur within the same epoch, which amortizes the performance costs of the synchronization operations to establish the memory window.

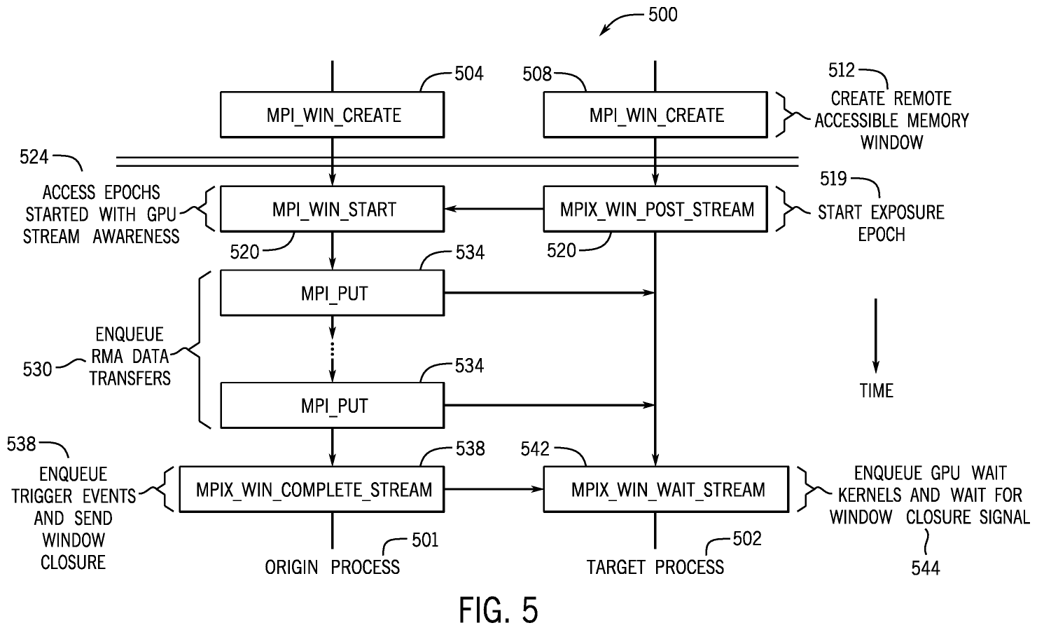

In accordance with example implementations, the host process serves as both the origin process and the target process to perform MPI active RMA communications for purposes of enqueuing the synchronization kernels into the GPU stream, and enqueuing the triggered network communication operations and signal operations on the NIC 132. More specifically, in accordance with example implementations, the host process uses an MPI active RMA communication model in accordance with a flow sequence 500 that is depicted in FIG. 5. Referring to FIG. 5, the host process serves as both an origin process 501 and a target process 502 in the flow sequence 500. The target process 502 corresponds to the target memory locations of the GPU and NIC.

For the following discussion, the MPI operations correspond to MPI calls made by the application. The flow sequence 500 first includes the host process creating a remote accessible memory window (as depicted at 512), using MPI_WIN_CREATE operations 504 and 508 for the origin process 501 and the target process 520. Next, the host process uses an MPIX_WIN_POST_STREAM operation 520 to start the exposure epoch (as depicted at 519) and signal an MPI_WIN_START operation 524 to start the access epoch, as depicted at 524. As depicted in FIG. 5, the flow 500 includes enqueuing one or multiple RMA data transfer operations (e.g., one or multiple MPI_PUT operations) to the NIC 132, as depicted at 530. To close the window, the host process may call an MPIX_WIN_COMPLETE STREAM operation 534 to enqueue trigger kernels to the GPU stream and enqueue completion signal operations to the NIC 132, as depicted at 538. Moreover, the host process may call an MPIX_WIN_WAIT_STREAM operation 542 to enqueue wait kernels in the GPU stream and close the exposure epoch, as depicted at 544.

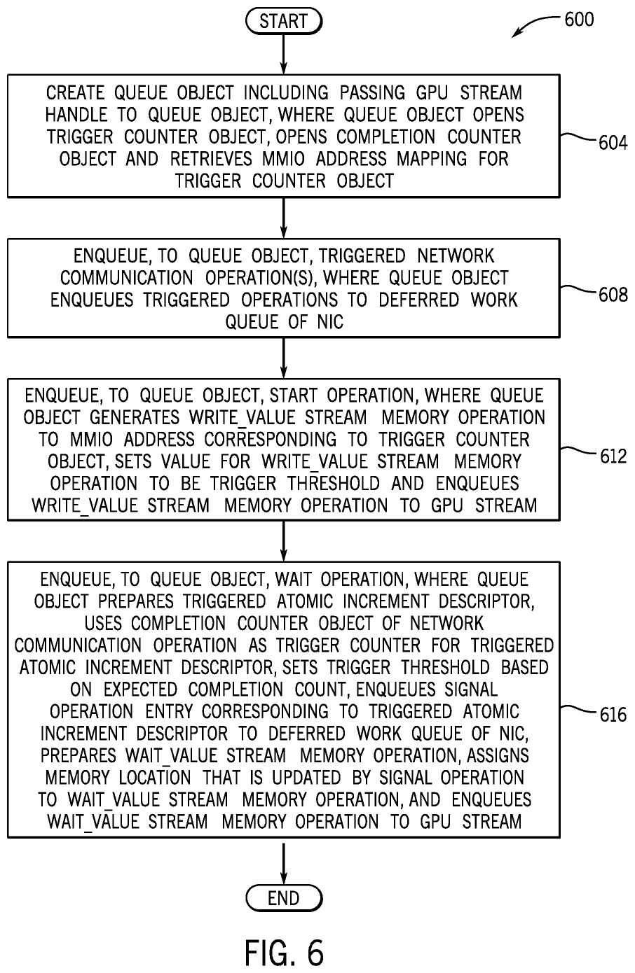

In accordance with further example implementations, the host process may not use two-sided communications, but instead may use process-to-process communications to enqueue the synchronization kernels into the GPU stream and enqueue the triggered network communication operations and signal operations into the NIC 132. More specifically, referring to FIG. 6, in accordance with example implementations, the host process may perform a technique 600 that includes creating (block 604) a queue object, including passing a GPU stream handle to the queue object. The queue object performs MPI send and MPI receive operations, as further described below. Pursuant to block 604, the queue object opens a trigger counter object, opens a completion counter object and retrieves an MMIO address mapping for the trigger counter object.

Pursuant to block 608, the host process enqueues, to the queue object, one or multiple triggered network communication operations. In this manner, the queue object, in response to the enqueuing of the triggered network communication operations, may enqueue corresponding entries in a deferred work queue of a NIC. Pursuant to block 612, the host process may further enqueue a start operation to the queue object. The start operation initiates actions by the queue object to enqueue a trigger kernel to the GPU stream for the enqueued triggered network communication operations. In accordance with example implementations, the queue object may generate a “write_value” stream memory operation to the MMIO address corresponding to the trigger counter object. Moreover, the queue object may set the value written by the write_value stream memory operation to be the trigger threshold, and the queue object may then enqueue the “write_value” stream memory operation to the GPU stream.

Pursuant to block 616, the technique 600 may include enqueuing, to the queue object, a wait operation. In response to the wait operation, in accordance with example implementations, the queue object may prepare an atomic increment descriptor to cause the NIC to generate the signal that triggers the end of the waiting by the wait kernel. The queue object sets the trigger counter for the atomic increment descriptor to be the completion counter of the network operation whose completion triggers the generation of the signal. The queue object then enqueues the triggered atomic descriptor with the associated triggered counter and threshold count value to the deferred work queue of the NIC. The queue object then prepares the “wait_value” stream” memory operation, assigns the memory location that is updated by the execution of the signal operation to the “wait_value” stream memory operation and enqueues the “wait_value” stream memory operation to the GPU stream.

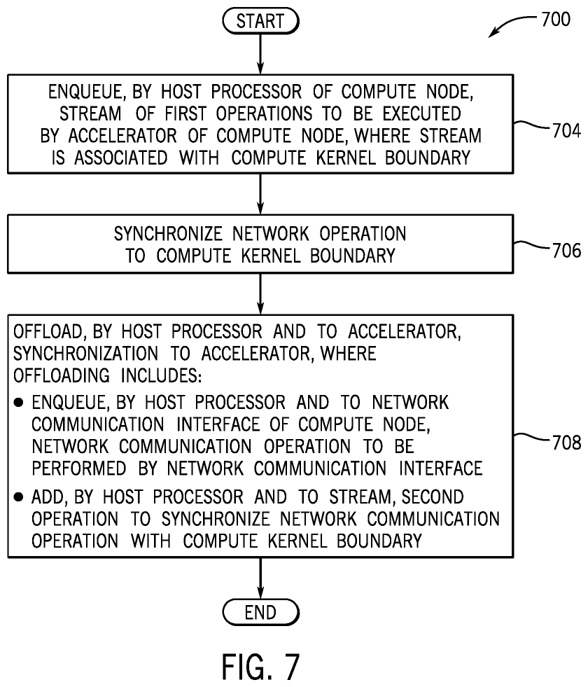

Referring to FIG. 7, in accordance with example implementations, a technique 700 includes enqueueing (block 704), by a host processor of a compute node, a stream of first operations to be executed by an accelerator of the compute node. In accordance with example implementations, the accelerator may be a GPU. In accordance with further example implementations, the accelerator may be a DSP or FPGA. The compute node may correspond to an operating system instance. The stream of first operations may include operations to launch compute kernels that are executed by the accelerator. The stream is associated with a compute kernel boundary. In an example, a compute kernel boundary may correspond to the launching of execution of a compute kernel. As another example, a compute kernel boundary may correspond to the completion of a compute kernel execution.

The technique 700 includes synchronizing (block 706) a network operation to the compute kernel boundary. In accordance with example implementations, the network operation may be an operation to send a payload (e.g., one or multiple packets containing payload data) to another compute node. In another example, the network operation may be an operation to receive payload data (e.g., receive one or multiple packets containing payload data) from another compute node. In accordance with some implementations, the network operation may communicate compute kernel execution result data from the compute node to another compute node. In accordance with some implementations, the network operation may communicate input data for kernel execution on the compute node from another compute node.

The technique 700 includes offloading (block 708), by the host processor and to the accelerator, the synchronizing to the accelerator. The offloading (block 708) includes enqueueing, by the host processor and to a network communication interface of the compute node, a network communication operation to be performed by the network communication interface. In accordance with example implementations, the network communication interface may be a network interface controller (NIC) of the compute node.

The offloading (block 708) further includes adding, by the host processor and to the stream, a second operation to synchronize the network operation with the compute kernel boundary. In accordance with example implementations, the second operation may be a trigger kernel to trigger the network operation responsive to the completion of execution of a compute kernel by the accelerator. In accordance with some implementations, the second operation may be a wait kernel to cause the accelerator to wait for the network operation to complete before launching the execution of a compute kernel.

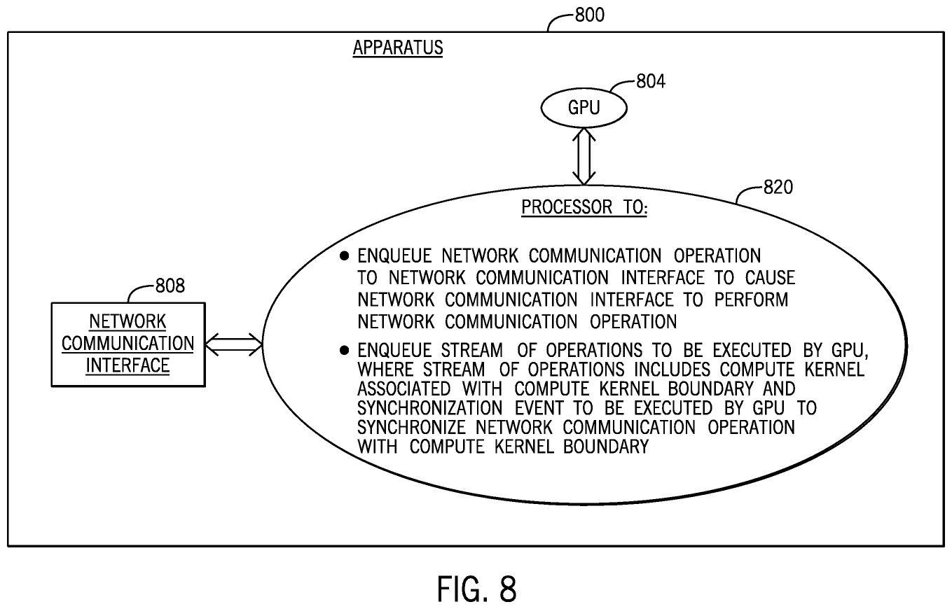

Referring to FIG. 8, in accordance with example implementations, an apparatus 800 includes a network communication interface 808, a graphics processing unit (GPU) 804, and a processor 820. In an example, the processor 820 may be a CPU. In an example, the network communication interface 808 may be a NIC. In an example, the apparatus 800 may correspond to a compute node, and the compute node may be associated with a particular operating system instance. The processor 820 may execute a steam triggered communication aware application to provide a host process that offloads, to the GPU 804, control paths to control synchronization between compute kernel boundaries and operations of the network communication interface 808.

The processor 820 enqueues a network communication operation to the network communication interface 808 to cause the network communication interface 808 to perform a network communication operation. In an example, the processor 820 may enqueue an entry in a triggered operation queue of the network communication interface, which represents the network communication operation. The processor 820 enqueues a stream of operations to be executed by the GPU 804. In an example, the stream of operations may correspond to operations that are enqueued and processed by a control processor of the GPU 804.

The stream of operations includes a compute kernel that is associated with a compute kernel boundary and a synchronization event that is executed by the GPU 804 to synchronize the network communication operation with the compute kernel boundary. In an example, the compute kernel boundary may correspond to a completion of the execution of the compute kernel by the GPU 804, and the synchronization event may be a trigger kernel that causes the GPU 804 to generate a trigger to cause the network communication interface to initiate the network communication operation. In an example, the compute kernel boundary may correspond to a launching of the compute kernel, and the synchronization event may be a wait kernel that causes the GPU 804 to wait for the network communication operation to complete.

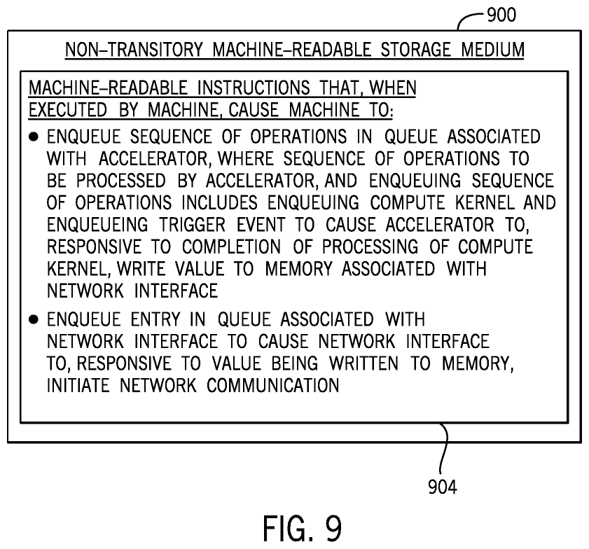

Referring to FIG. 9, in accordance with example implementations, a non-transitory machine-readable storage medium 900 stores instructions 904. The instructions 904, when executed by a machine, cause the machine to enqueue a sequence of operations in a queue associated with an accelerator. In an example, the accelerator may be a GPU. In accordance with other examples, the accelerator may be a DSP or an FPGA. In an example, the queue may be associated with a control processor of the GPU. In an example, the instructions 904 may be associated with a stream triggered communication aware application. In an example, the instructions 904 may be associated with a host process that processes a rank of a job.

The sequence of operations is to be processed by an accelerator. Enqueuing the sequence of operations includes enqueuing a compute kernel and enqueueing a trigger event to cause the accelerator to, responsive to completion of processing of the compute kernel, write a value to a memory that is associated with a network interface. In an example, the trigger event may be a memory stream write operation to write a value to a memory-mapped register. In an example, the trigger event may be enqueued to a queue that is associated with a control processor of the accelerator.

The instructions 904, when executed by the machine, further cause the machine to enqueue an entry in a deferred work queue associated with the network interface to cause the network interface to, responsive to the value being written to the memory, initiate a network communication. In an example, the network interface may be a NIC. In an example, the entry may include a command descriptor that represents a network send operation to send one or multiple packets. In an example, the entry may include a command descriptor that represents a network send operation to receive one or multiple packets. In an example, the entry may identify a trigger counter of the network interface and a threshold count value for the trigger counter, such that when the trigger counter has a value that equals or exceeds the threshold count value, the network interface executes a command represented by a command descriptor of the entry. In an example, the entry may identify a completion counter of the network interface, which has an expected completion count value when the network operation associated with the entry completes.

In accordance with example implementations, the compute kernel boundary corresponds to a completion of execution of a compute kernel by the accelerator. The network communication interface initiates the network communication operation responsive to a trigger. Adding the second operation includes adding, by the host processor, one of a trigger kernel or a “write_value” stream operation to the stream to cause the accelerator to provide the trigger. Among the potential advantages, synchronization control paths (e.g., control paths to coordinate MPI-based messaging by a network interface with compute kernel boundaries) are offloaded from the host processor to the accelerator, which may improve the performance (e.g., shorten execution times) of a parallel processing system.

In accordance with example implementations, enqueueing the first network communication operation includes enqueueing, by the host processor, an entry to a deferred work queue of the network communication interface. The entry contains a command corresponding to the first network communication operation. The entry identifies a trigger counter of the network communication interface and a threshold value for a count value of the trigger counter. The technique further includes the accelerator providing the trigger, wherein the accelerator providing the trigger comprises the accelerator changing the count value to be the same as or greater than the threshold value. Among the potential advantages, synchronization control paths are offloaded from the host processor to the accelerator, which may improve the performance of a parallel processing system.

In accordance with example implementations, the compute kernel boundary corresponds to an initiation of execution of a compute kernel by the accelerator. Enqueueing the first network communication operation includes enqueueing, by the host processor, a first entry to a deferred work queue of the network communication interface. The first entry identifies a completion counter of the network communication interface to provide a count value to indicate completion of the first network communication operation. Adding the second operation includes adding, by the host processor, a wait event to the stream to cause the accelerator to initiate execution of the compute kernel responsive to the completion counter providing the count value. Among the potential advantages, synchronization control paths are offloaded from the host processor to the accelerator, which may improve the performance of a parallel processing system.

In accordance with example implementations, offloading the synchronizing to the accelerator further includes enqueueing, by the host processor and to the network communication interface, a second operation corresponding to the network communication interface to provide, by the network communication interface, a signal to the accelerator to represent the completion of the first network communication operation. The offloading includes chaining the second operation to the first network communication operation. Among the potential advantages, synchronization control paths are offloaded from the host processor to the accelerator, which may improve the performance of a parallel processing system.

In accordance with example implementations, chaining the second operation to the first network communication operation includes enqueueing, by the host processor, a second entry to the deferred work queue. The second entry identifies the completion counter as being a trigger counter to initiate the second operation. Among the potential advantages, synchronization control paths are offloaded from the host processor to the accelerator, which may improve the performance of a parallel processing system.

In accordance with example implementations, enqueueing the second operation includes enqueuing an operation to write, by the network communication interface, a value to an accelerator-attached memory of the compute node to provide the signal. Among the potential advantages, synchronization control paths are offloaded from the host processor to the accelerator, which may improve the performance of a parallel processing system.

In accordance with example implementations, the first network communication operation includes an operation to communicate data corresponding to a result of the processing of a compute kernel by the accelerator. Among the potential advantages, synchronization control paths are offloaded from the host processor to the accelerator, which may improve the performance of a parallel processing system.

In accordance with example implementations, enqueueing the first network communication operation and adding the second operation include generating, by the host processor, Message Passing Interface (MPI) application programming interface (API) calls. Among the potential advantages, synchronization control paths are offloaded from the host processor to the accelerator, which may improve the performance of a parallel processing system.

In accordance with example implementations, enqueueing the first network communication operation and adding the second operation include using, by the host processor Message Passing Interface (MPI) active remote memory interface (RMA)-based communication. Among the potential advantages, synchronization control paths are offloaded from the host processor to the accelerator, which may improve the performance of a parallel processing system.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method comprising:
enqueueing, by a host processor of a compute node, a stream of first operations to be executed by an accelerator of the compute node, wherein the stream is associated with a compute kernel boundary;
synchronizing a network operation to the compute kernel boundary; and
offloading, by the host processor and to the accelerator, the synchronizing to the accelerator, wherein the offloading comprises:
enqueueing, by the host processor and to a network communication interface of the compute node, a first network communication operation to be performed by the network communication interface; and
adding, by the host processor and to the stream, a second operation to synchronize the first network communication operation with the compute kernel boundary.

2. The method of claim 1, wherein:
the compute kernel boundary corresponds to a completion of execution of a compute kernel by the accelerator;
the network communication interface initiates the network communication operation responsive to a trigger; and
adding the second operation comprises adding, by the host processor, one of a trigger kernel or a write value stream operation to the stream to cause the accelerator to provide the trigger.

3. The method of claim 2, wherein:
enqueueing the first network communication operation comprises enqueueing, by the host processor, an entry to a deferred work queue of the network communication interface;
the entry contains a command corresponding to the first network communication operation; and
the entry identifies a trigger counter of the network communication interface and a threshold value for a count value of the trigger counter; and
the method further comprises the accelerator providing the trigger, wherein the accelerator providing the trigger comprises the accelerator changing the count value to be the same as or greater than the threshold value.

4. The method of claim 1, wherein:
the compute kernel boundary corresponds to an initiation of execution of a compute kernel by the accelerator;
enqueueing the first network communication operation comprises enqueueing, by the host processor, a first entry to a deferred work queue of the network communication interface;
the first entry identifies a completion counter of the network communication interface to provide a count value to indicate completion of the first network communication operation; and
adding the second operation comprises adding, by the host processor, a wait kernel to the stream to cause the accelerator to initiate execution of the compute kernel responsive to the completion counter providing the count value.

5. The method of claim 4, wherein offloading the synchronizing to the accelerator further comprises:
enqueueing, by the host processor and to the network communication interface, a second operation corresponding to the network communication interface to provide, by the network communication interface, a signal to the accelerator to represent the completion of the first network communication operation; and
chaining the second operation to the first network communication operation.

6. The method of claim 5, wherein chaining the second operation to the first network communication operation comprises:
enqueueing, by the host processor, a second entry to the deferred work queue, wherein the second entry identifies the completion counter as being a trigger counter to initiate the second operation.

7. The method of claim 5, wherein enqueueing the second operation comprises enqueuing an operation to write, by the network communication interface, a value to an accelerator-attached memory to provide the signal.

8. The method of claim 1, wherein the first network communication operation comprises an operation to communicate data corresponding to a result of the processing of a compute kernel by the accelerator.

9. The method of claim 1, wherein enqueueing the first network communication operation and adding the second operation comprise generating, by the host processor, Message Passing Interface (MPI) application programming interface (API) calls.

10. The method of claim 1, wherein enqueueing the first network communication operation and adding the second operation comprise using, by the host processor Message Passing Interface (MPI) active remote memory interface (RMA)-based communication.

11. An apparatus comprising:
a network communication interface;
a graphics processing unit (GPU); and
a processor other than the GPU to:
enqueue a first network communication operation to the network communication interface to cause the network communication interface to perform the first network communication operation; and
enqueue a stream of operations to be executed by the GPU, wherein the stream of operations comprises a compute kernel associated with a compute kernel boundary and a synchronization event to be executed by the GPU to synchronize the first network communication operation with the compute kernel boundary.

12. The apparatus of claim 11, wherein:
the GPU comprises a plurality of cores and a GPU processor;
the compute kernel boundary corresponds to a completion of execution of a compute kernel by at least one core of the plurality of cores;
the network communication interface to initiate the first network communication operation in response to a trigger; and
the control GPU processor executes the synchronization event to provide the trigger.

13. The apparatus of claim 11, wherein:
the GPU comprises a plurality of cores and a GPU processor;
the compute kernel boundary corresponds to an initiation of execution of a compute kernel by at least one core of the plurality of cores;
the network communication interface indicates completion of the first network communication operation; and
the control GPU processor executes the synchronization event to cause the control processor to wait for the network communication interface to indicate completion of the first network communication operation before the GPU processor initiates execution of the compute kernel.

14. The apparatus of claim 13, wherein:
the processor to further enqueue a second operation to the network communication interface to cause the network communication interface to update a GPU-attached memory in response to the network communication interface indicating completion of the first network communication operation; and
the GPU processor polls the GPU-attached memory to detect the update; and
the GPU processor initiates execution of the compute kernel responsive to the polling detecting the update.

15. The apparatus of claim 14, wherein each compute node of the plurality of compute nodes is associated with a different operating system instance of a plurality of operating system instances.

16. The apparatus of claim 11, wherein:
the processor is associated with a first process;
the network communication interface comprises a network interface controller; and
the first network communication operation comprises at least one of a send operation to communicate, to a second process, data associated with the first process and representing compute kernel output data, or a receive operation to communicate, to the first process, data associated with the second process and representing compute kernel input data.

17. A non-transitory machine-readable storage medium to store instructions that, when executed by a machine, cause the machine to:
enqueue a sequence of operations in a queue associated with an accelerator, wherein sequence of operations to be processed by the accelerator, and enqueuing the sequence of operations comprises enqueuing a compute kernel and enqueueing a trigger event to cause the accelerator to, responsive to completion of processing of the compute kernel, write a value to a memory associated with a network interface; and
enqueue an entry in a deferred work queue associated with the network interface to cause the network interface to, responsive to the value being written to the memory, initiate a network communication.

18. The storage medium of claim 17, wherein the network communication comprises a Message Passing Interface (MPI) operation associated with processing of the kernel.

19. The storage medium of claim 17, wherein the instructions, when executed by the machine, further cause the machine to enqueue the trigger event and enqueue the entry in the network interface using Message Passing Interface (MPI) communications.

20. The storage medium of claim 19, wherein MPI communications comprise MPI remote memory access (RMA) communications.
